(19) United States
(12) Patent Application Publication
(10) Pub. No.: US 2018/0125125 A1
(43) Pub. Date: May 10, 2018

(54) NOVEL JACKET WITH HANDLING MECHANISMS

(71) Applicant: ANTHONY DASHON THORNTON, East Palo Alto, CA (US)

(72) Inventor: ANTHONY DASHON THORNTON, East Palo Alto, CA (US)

(73) Assignee: ANTHONY DASHON THORNTON, East Palo Alto, CA (US)

(21) Appl. No.: 15/792,748

(22) Filed: Oct. 24, 2017

Related U.S. Application Data
(60) Provisional application No. 62/410,391, filed on Oct. 20, 2016.

(51) Int. Cl. A41D 13/00; A41D 3/00; B62J 27/00

(52) U.S. Cl. CPC A41D 13/0002; A41D 3/00; A41D 13/0015; B62J 2027/005; A41D 2600/102; A41D 2400/82; B62J 27/00

(57) ABSTRACT

This disclosure pertains to a novel motorcycle jacket used to improve safety during motorcycle rides. A novel motorcycle jacket may include one or more handles, disposed in one more orientations, thereon. The novel motorcycle jacket facilitates ease of grip with the handles which provide safety for motorcycle passengers. The novel motorcycle jacket may comprise a plurality of handles, a coupling means that attaches the plurality of handles to the body of a jacket. The motorcycle jacket may comprise a flexible material to facilitate lateral forces to apply thereon.

### PRIORITY

The patent disclosure claims priority U.S. provisional patent application Ser. No. 62/410,391 filed on Oct. 20, 2016 which is incorporated herein in its entirety.

### FIELD OF THE DISCLOSURE

This disclosure pertains to a novel motorcycle jacket used to improve safety during motorcycle rides.

### BRIEF DESCRIPTION OF THE FIGURES

To facilitate understanding, identical reference numerals have been used, wherever possible, to designate identical elements that are common to the figures. The drawings are not to scale and the relative dimensions of various elements in the drawings are depicted schematically and not necessarily to scale. The techniques of the present invention may readily be understood by considering the following detailed description in conjunction with the accompanying drawings, in which:

FIG. 1 depicts a novel motorcycle jacket apparatus with handle mechanism(s) thereon.

FIG. 2 depicts a close-up view of a handle mechanism coupled to a novel motorcycle jacket apparatus disclosed herein.

FIG. 3 depicts numerous locations where one or more handle mechanisms can be attached to the motorcycle jacket apparatus.

FIG. 4 depicts a side view of a manner in which the novel motorcycle jacket apparatus is used during operation.

### DETAILED DESCRIPTION

The description of the different advantageous embodiments has been presented for purposes of illustration, and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

Before the present invention is described in detail, it is to be understood that, unless otherwise indicated, this disclosure is not limited to specific procedures or articles, whether described or not.

It is further to be understood that the terminology used herein is for the purpose of describing particular embodiments only and is not intended to limit the scope of the present invention.

It must be noted that as used herein and in the claims, the singular forms “a,” and “the” include plural referents unless the context clearly dictates otherwise.

Where a range of values is provided, it is understood that each intervening value, to the tenth of the unit of the lower limit unless the context clearly dictates otherwise, between the upper and lower limit of that range, and any other stated or intervening value in that stated range, is encompassed within the disclosure. The upper and lower limits of these smaller ranges may independently be included in the smaller ranges, and are also encompassed within the disclosure, subject to any specifically excluded limit in the stated range. Where the stated range includes one or both of the limits, ranges excluding either or both of those included limits are also included in the disclosure. The term “about” generally refers to ±10% of a stated value.

A wearable apparatus is disclosed herein. A motorcycle jacket apparatus consistent with the present disclosure comprises a motorcycle jacket assembly. The motor jacket assembly comprises a first handle and a second handle. The first handle may be attached to a first side of a jacket and comprises a first button operable to create an alert. The second handle attached to a second side of the jacket and the second handle comprises a second button that is operable to create an alert.

In addition, the motorcycle jacket apparatus also includes a first alert indicator disposed upon a first surface area of the jacket. The first alert indicator to receive an alert signal from the first button of the first handle and the second button of the second handle. An integrated circuit of electronics disposed within the interior of the jacket. The integrated circuit of electronics electrically coupled to the first button of the first handle, the second button of the second handle, and the first alert indicator.

An object of the invention is a motorcycle jacket apparatus with handle mechanisms affixed thereto. The handle mechanisms may be referred to as handles which operate to allow a motorcycle passenger to grip thereto during a ride. The handles provide additional support for the passenger while riding on the motorcycle. As safety is paramount, the novel motorcycle jacket apparatus described herein may increase safety and thereby reduce the amount of injuries associated with motorcycle riding.

It is further an object of the present invention to enable the handles to be coupled to the motorcycle jacket apparatus by any of various means. In one embodiment, the handles are stitched to the motorcycle jacket apparatus. In other embodiments, each handle may be part of a handle assembly which is stitched to the motorcycle jacket apparatus.

Additionally, the handle assembly may in fact be coupled to the motorcycle jacket apparatus via a zipper mechanism that cooperates with a zipper feature on the jackets. A button arrangement may also be implemented. However, the present disclosure is not limited thereto. The handles may be coupled to the motorcycle jacket apparatus by any of various means.

In a preferred embodiment, two handles are coupled to the motorcycle jacket apparatus but the present disclosure is not limited thereto. In other embodiments, a single handle is coupled to the motorcycle jacket apparatus which may allow the passenger to have a greater range of freedom with the hand that is not in contact with the handle.

In some embodiments, four handles are coupled to the motorcycle jacket apparatus. As such, a passenger can choose to hold on to the handles in a first range or a second range. For example, the first set of handles may be nearer to the back of the motorcycle jacket apparatus than the second set of handles. As such, the novel motorcycle jacket apparatus disclosed herein may accommodate passengers of various sizes (e.g., arm lengths). The motorcycle jacket apparatus may comprise an even number of handles to ensure that the passenger has various sets of handles to choose from which vary in distance from the passenger.

In one or more embodiments, the handles are disposed vertically along the motorcycle jacket apparatus. However, the present disclosure is not limited thereto. The handles may be disposed in either vertical, horizontal, or diagonal fashion so long as they provide ease of grip to provide greater protection for the passenger.

Thus, the motorcycle jacket apparatus may comprise a set of vertical, horizontal, or diagonally disposed handles, or otherwise, sets of vertical, horizontal, and/or diagonally disposed handles thereon. In some embodiments, sets of handles span the length of the motorcycle jacket apparatus.

The handles may be of any suitable size. In some embodiments, the handles are long enough to allow the passenger to fully grip the handle. Furthermore, the handles may have grip treads to facilitate ease of gripping. Most notably, the present invention may incorporate any type of handles that allows ease of grip such that the present disclosure can effectively hold close to the motorcycle driver.

The placement of the handles may be strategically located such that they do not impede access to one or more pockets in the jacket. In some embodiments, the handles are placed in the lower front area of the jacket such that they are in proximity to the driver's abdominal area. In alternative embodiments, the handles may be placed on the sides of the jacket. However, the present invention is not limited to any particular placement on the motorcycle jacket apparatus so long as the passenger can effectively grip the handles thereon.

In some embodiments, the handles may be placed at the same height on the jacket. However, in other embodiments, the handles may be at different heights such that they render a cascade effect on the motorcycle jacket apparatus.

The material of the motorcycle jacket apparatus should comprise materials to withstand pulling or shearing thereto. Most importantly, it is an object of the present disclosure to have the motorcycle jacket withstand significant shearing forces to prevent the jacket from tearing during use. In some embodiments, the motorcycle jackets described herein may be made of leather or any other suitable material known in the art.

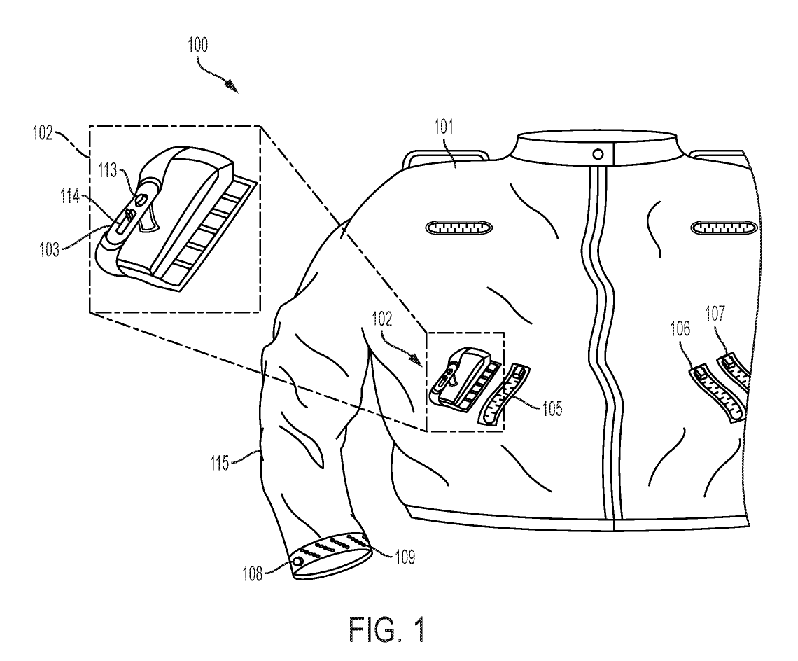

FIG. 1 depicts a novel motorcycle jacket apparatus 100 with handle mechanism(s) thereon. Motorcycle jacket apparatus 100 comprises several features, according to design, which provides safer motorcycle rides for passengers. As shown in the figure, motorcycle jacket apparatus 100 comprises a jacket 101, handle assembly 102, handle tracks 105, 106, 107, and output indicators 108, 109. It should be understood by those having ordinary skill in the art that the present invention is not limited to a motor jacket configuration. The present invention is amenable to include any coat, jacket, vest, or other article of clothing which is to be donned on a human torso.

Notably, motorcycle jacket apparatus 100 includes a plurality of handle tracks 105, 106, 107 by which one or more handle assemblies 102 can be coupled to the motorcycle apparatus 100. Accordingly, the handle assemblies 102 can be attached or detached according to one's need. In some embodiments, the handle tracks include zipper components which cooperate with zipper components disposed on the base attachment portion of the handle assemblies 102. The various handle tracks 105, 106, 107 on the jacket 101 allows a passenger riding on the back of a motorcycle to maximize comfort and usefulness according to the passenger's preference.

In addition, although the handle assembly 102 and handle tracks 105, 106, 107 are disposed diagonally on the jacket 101, the present invention is not limited thereto. The handle assemblies and tracks may be disposed vertically or horizontally and this would be within the spirit and scope of the present invention. Moreover, the present invention is also not limited to handles assemblies and tracks that are all disposed in the same orientation upon the jacket 101. For example, on one side of the jacket 101, the handle assembly 105 may be disposed in a first diagonal direction whereas on another side of the jacket 101, the handle assembly 105 is disposed in an opposing diagonal direction.

The material composition of the motorcycle jacket apparatus 100 may include flexible materials to account for shearing forces that are exerted on the jacket 101 when the passenger pulls upon the handle assemblies 102 according to some embodiments of the present invention. However, the jacket 101 is durable to withstand shearing forces exerted thereon in addition to also having flexible/pliable material properties. Accordingly, the motorcycle jacket apparatus 100 operates such that during use, passengers can secure themselves without yielding to shearing stresses exerted onto the jacket 101.

In some embodiments, the handle assembly 102 comprises a handle portion 103, a base attachment portion 104, and alert button 113, displacement lever 114. The handle portion 103 of the assembly 102 allows a passenger to form a grip upon the assembly 102. The base attachment portion 104 facilitates coupling the handle assembly 102 to the jacket 101. The alert button 113 allows a user to communicate with the driver that an unsafe condition is present for the passenger such that the driver can adjust the speed of the vehicle accordingly.

As will be explained in more detail below, motorcycle jacket assembly 100 comprises electronics that facilitates communications to various areas of the jacket 101. For example, when alert button 113 is engaged, the alert output indicators 108, 109 (at the end of sleeve 115 of the jacket 101) engages accordingly. As such, the present invention facilitates communication from a passenger to a driver of a vehicle without the use of an audible means by the passenger.

Alert output indicators 108, 109 may be any of a vibration means, an audible means, or a visual meas. For example, alert output indicator 109 may include haptics to enable vibration or any other physical output to alert the driver that an unsafe condition is present for the passenger. In addition, alert output indicator 109 may include any of several visual mechanisms such as a light blinking sequence to inform the user of the passenger's communications. In one embodiment, alert output indicator 108, may emanate an audible signal to alert the driver. It should be understood by one having ordinary skill in the art that the present invention is not limited to any one alert output indicator. Moreover, a combination of alert output indicators may be used so long as any combination does not pose a safety hazard to the driver when in use.

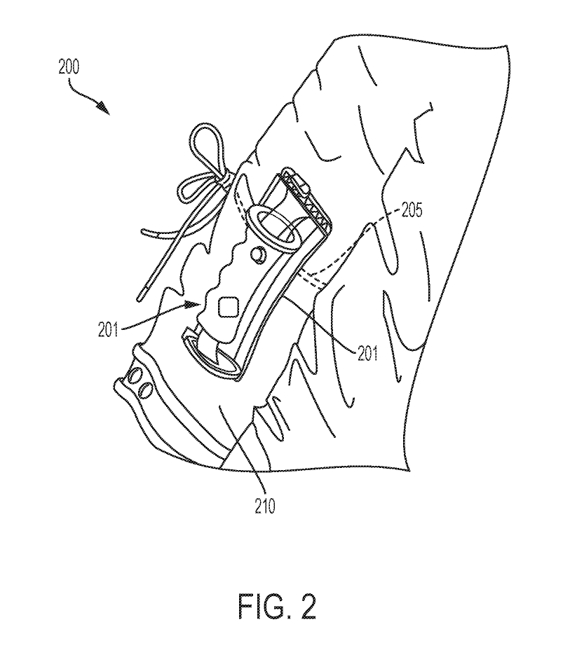

FIG. 2 depicts a close-up view of a handle assembly 201 coupled to a novel motorcycle jacket apparatus disclosed herein. In the embodiment shown, handle assembly 201 is permanently attached to the jacket 210 portion of the motorcycle jacket assembly. In one or more embodiments of the present disclosure, the base attachment portion 202 is coupled to the jacket 210 by a stitching mechanism as shown by the partial stitching 205 in the figure. It should be understood, however, that the present invention is not limited to stitching but is amendable to incorporate any means to permanently attach the handle assembly 201 to the jacket 210.

Therefore, as previously discussed, the motorcycle jacket assembly may be configured to include either permanent or detachable handle assemblies. In some implementations, the motorcycle jacket assembly comprises a set of permanent handle assemblies and placement (e.g., handle tracks) for detachable handle assemblies as well.

Moreover, in some embodiments of the present invention, the handle assemblies may incorporate electronics to communicate with an external device (e.g., a smartphone device). For example, handle assembly 200 comprises wireless electronics which allow wireless communication to a smartphone device. As such, each time that handle assembly 200 is engaged, a signal is not only sent to an alert output indicator (as described below) but also to a smartphone device which may have a software application that tracks the alerts, informs third parties, and records data pertinent to the present ride (e.g., speed, acceleration, etc.). As known in the art, handle assembly 200 may be powered by a battery component (e.g., rechargeable batteries).

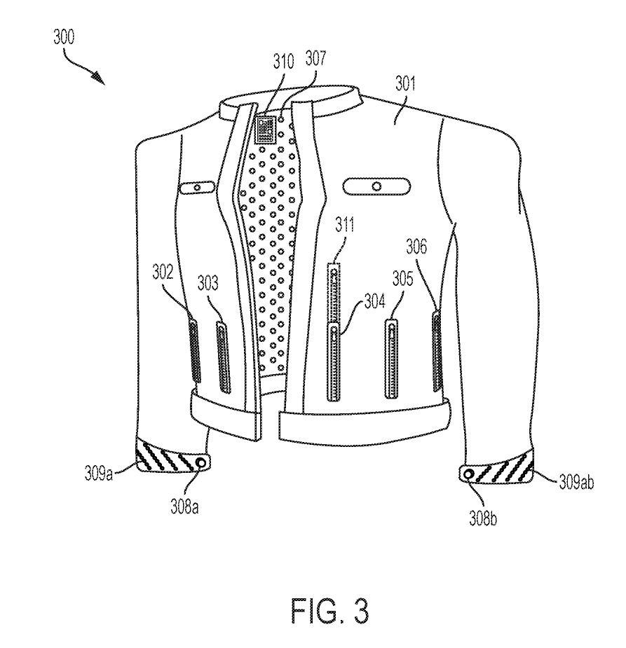

FIG. 3 depicts numerous locations where one or more handle assemblies can be attached to the motorcycle jacket apparatus 300. As shown, motorcycle jacket apparatus 300 includes a plurality of handle tracks 302-306 all disposed on the surface of jacket 301. In the embodiment shown, handle tracks 302-306 allow for the attachment of one or more handle assemblies.

Most notably, motorcycle jacket apparatus 300 shows a plurality of electrical leads 307 which span various internal areas of the apparatus 300. The electrical leads 307 may all be coupled to a power-communications hub 310 from which the electronic system of the motorcycle jacket apparatus 300 can draw power. In some implementations, power-communications hub 310 can also direct communications within the motorcycle jacket apparatus 300. As such, motorcycle jacket apparatus 300 may be classified as a wearable device as it incorporates electronics to facilitate electronic applications.

For example, in one embodiment, when the handle assemblies are attached to the jacket 301 and engaged, electrical signals are dispatched from the handle assemblies to the power-communications hub which in turns sends one or more signals to the alert output indicators 308a, 308b, 309a, 309b. The power-communications hub may be programmed to send an electrical signal to specific alert output indicators 308a, 308b, 309a, 309b according to the specific handle assembly that was engaged. For example, the power-communications hub 310 that receives an electrical signal from a handle assembly on a first side of the motorcycle jacket assembly 300 may send an electrical signal to the alert output indicators 308a, 308b, 309a, 309b that are disposed on this first side of the motorcycle assembly 300.

In yet another embodiment of the present disclosure, electrical leads 307 are coupled to the power-communications hub 310 such that the hub 310 routes signals to the pre-assigned alert output indicators 308a, 308b, 309a, 309b. As such, the routing of signals to the alert output indicators 308a, 308b, 309a, 309b are a function of the handle tracks 302-306 and not necessarily to the handle assemblies themselves. Therefore, in some embodiments, rotating the handle assemblies to different handle tracks will not change the routing scheme or communication paths within the motorcycle jacket apparatus 300.

Furthermore, the motorcycle jacket apparatus 300 can be configured such that the power-communications hub 310 routes an alert signal to all of the alert output indicators 308a, 308b, 309a, 309b when an electrical signal is received from a particular handle track. For example, handle track 302 may be electrically coupled to handle track 308a, 308b, 309a, 309b whereas handle tacks 303-306 may be electrically coupled to 308a, 308b, 309a, and 309b, respectively.

In addition, the length of tracks 302-306 may be substantially longer than the length of the handle assemblies that are to be attached thereto (extended track 311). In some implementations, the handle tracks 302-306 may each include motors to move the handle assemblies to various positions along the track. For example, a dedicated button on the handle portion of the handle assembly may change its position along the handle track. For handle tracks that are horizontally disposed, changing the position of the handle assemblies along the handle track may allow a passenger to get more secure or assume a lax posture with respect to the driver.

For instance, if the passenger sees ahead that a curve is approaching, the passenger may engage a lever (either left or right) on one or more of the attached handle assemblies so that the passenger can hold onto the driver more securely. Alternatively, if the passenger sees that there is a straight path, the passenger can engage the lever to move the handle assembly to a position that relaxes the passenger's position relative to the driver.

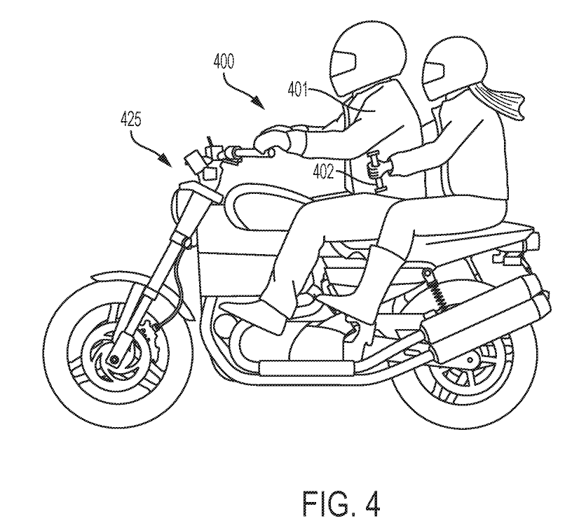

FIG. 4 depicts a side view of a manner in which the novel motorcycle jacket apparatus 400 is used during operation. The figure illustrates a driver and passenger riding on a motorcycle 425. Notably, the driver is donning a motorcycle jacket assembly 400 consistent with the present invention. The passenger is shown holding on to the driver via the handle assemblies 402 of the jacket 401. As the motorcycle jacket apparatus 400 provides a secure means from which the passenger can hold onto the driver, the passenger is able to ride safer than when

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in some embodiments” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

1. An apparatus, comprising:
a jacket assembly, comprising:
at least one handle; and
a coupling means that attaches the at least one handle to the body of a jacket;
wherein the jacket comprises a flexible material to facilitate lateral forces to apply thereon.

2. The apparatus of claim 1, wherein the coupling means comprises a first zipper component that is a member of the at least one handle and a second zipper component that is a member of the body of the jacket.

3. The apparatus of claim 1, wherein the at least one handle comprises a first handle coupled to a first side of the jacket and a second handle coupled to a second side of the jacket.

4. The apparatus of claim 1, wherein the at least one handle comprises a first set of handles coupled to a first side of the jacket and a second set coupled to a second side of the jacket wherein the first set of handles has a number of handles that exceeds the second set of handles.

5. The apparatus of claim 1, wherein the flexible material of the jacket is on a top surface of the jacket.

6. The apparatus of claim 1, wherein the flexible material of the jacket is within the body of the jacket.

7. The apparatus of claim 1, wherein the jacket is a motorcycle jacket.

8. The apparatus of claim 1, wherein the at least one handle comprises a slender member which facilitates a grip hand attachment.

9. The apparatus of claim 1, wherein the at least one handle comprises a button which is operable to create an alert.

10. The apparatus of claim 9, wherein the jacket assembly includes electronics integrated within the body of the jacket.

11. The apparatus of claim 10 further comprising an alert indicator to output an alert.

12. The apparatus of claim 11, wherein the alert indicator comprises at least one of a vibration means, an audible means, or a visual means.

13. A motorcycle jacket apparatus, comprising:
a first handle attached to a first side of a jacket, the first handle comprises
a first button operable to create an alert;
a second handle attached to a second side of the jacket, the second handle comprises a second button that is operable to create an alert;
a first alert indicator disposed upon a first surface area of the jacket, the first alert indicator to receive an alert signal from the first button of the first handle and the second button of the second handle; and
an integrated circuit of electronics disposed within the interior of the jacket, the integrated circuit of electronics electrically coupled to the first button of the first handle, the second button of the second handle, and the first alert indicator.

14. The motorcycle jacket apparatus of claim 13, wherein the first alert indicator comprises at least one of an audible alert, haptic alert, and visual alert.

15. The motorcycle jacket apparatus of claim 13 further comprising a second alert indicator disposed on a second area of the jacket and electrically coupled to the integrated circuit of electronics, the second indicator to output an alert that is different than the alert emitted by the second alert indicator.

16. The motorcycle jacket apparatus of claim 13, wherein the alert is an emergency alert.

17. The motorcycle jacket apparatus of claim 13, wherein the first handle and the second handle can transmit information to an external device.

18. The motorcycle jacket apparatus of claim 13, wherein the first handle is attached to a first track portion on the body of the jacket and the second handle is attached to a second track portion on the body.

19. The motorcycle jacket apparatus of claim 18, wherein the first handle comprises a first motor that propels the first handle in either direction along the first track and wherein the second handle comprises a second motor that propels the second handle in either direction along the second track.

20. The motorcycle jacket apparatus of claim 19, wherein upon activation of the first button and the second button, the first handle traverses along the first track and the second handle traverses along the second track in a direction
